(19) United States
(12) Patent Application Publication
(10) Pub. No.: US 2005/0108053 A1
(43) Pub. Date: May 19, 2005

(54) Interactive internet medical pharmaceutical prescribing system

(76) Inventor: Miles J. Jones JR., Liberty, MO (US)

Correspondence Address: GREENBERG & LIEBERMAN, 314 PHILADELPHIA AVE., TAKOMA PARK, MD, 20912, US

(21) Appl. No.: 10/972,644

(22) Filed: Oct. 25, 2004

Related U.S. Application Data
(60) Provisional application No. 60/481,641, filed on Nov. 14, 2003.

(51) Int. Cl. G06F 17/60

(52) U.S. Cl. 705/2

(57) ABSTRACT

A system that utilizes the Internet to offer medical advice and care for users/patients. Once the user accesses the website of the present invention, they can read about the services of the present invention, read about the services offered by the present invention, complete a medical questionnaire, consult with a licensed physician, obtain a medical prescription and have the prescription filled by a licensed pharmacist of the present invention. The present invention allows the user the privacy, convenience of the Internet and access to licensed physicians to inquire about medical conditions that are often embarrassing and uncomfortable topics to discuss during traditional face-to-face visits with doctors.

### CLAIM OF PRIORITY

Priority is hereby claimed to U.S. Provisional Application number 60/481,641 filed Nov. 14, 2003.

### FIELD OF THE INVENTION

The present invention relates to a computer program, and more particularly a program for medical consulting and prescribing medication using the Internet.

### BACKGROUND OF THE INVENTION

The forces that threaten medicine from without are daunting, chief among them being managed care with its unconscionable interference in the right of patients to have direct access to a physician of their choice, insurance companies with their outrageous interference in the obligation of physicians to manage patients optimally as they see fit, and government with what can be considered its unconstitutional interference in the practice of medicine. The major threat to medicine is from within, from medicine itself, and that danger imperils the very survival of the profession. Three of those threats are loss of focus (medicine is a profession, art and science not an industry), loss of commitment to education in all aspects of medicine (the patient and the practice of medicine as art and science must be the focus of training, not “billable events”), and loss of nerve (fear of doing the right thing professionally because of economic, political, legal, and societal constraints).

Many issues arise when determining the future of the medical profession and the accessibility of physicians for patients. Specifically, some of those issues are 1) whether physicians can treat patients with compassion and respect, and 2) whether the physicians can provide convenient, efficient and affordable methods of prescribing medications. There is a concern that many will not seek medical help from physicians due to embarrassment, inconvenience, and sheer distrust. Furthermore, many patients are aware of medication, and have conducted research and studies directed to the type of medication that they desire, however cannot request medications without going through the inconvenience and excess cost of visiting both the physician and the pharmacy.

Relevant art has attempted to facilitate the act of obtaining prescriptions by allowing pharmacies and doctors to order prescriptions and medical history by Internet, fax or phone. For example, U.S. Pat. Publication No. 2002/0052760, invented by Munoz et al. on May 2, 2002 illustrates a system that links data for prescription requests, prescription refill requests, medical history requests, and prescription request history in a database. While the Munoz invention allows physicians and pharmacists to obtain information quickly and easily, the user does not benefit greatly from the Munoz invention. The Munoz invention requires that a patient go to a physician, obtain a prescription, go to a pharmacy and receive the prescription. It still entails the inconvenience, inconsistency, risk, and possible embarrassment associated with face-to-face visits with physicians and pharmacists. It also does not allow the user to be drug specific when determining what type of prescription they want, because they are at the mercy of the physician's care and whims.

U.S. Pat No. 6,551,243, issued to Bocionek et al., on Apr. 22, 2003, illustrates a medical information system that processes information from multiple sources suitable for access by healthcare personnel for use in clinical care delivery. However, the Bocionek invention only provides easy access to information by medical personal, and not users or pharmacies. The Bocionek invention runs into the same problems with inconvenience, inconsistency, risk, embarrassment, and lack of user choice; therefore does not alleviate the problem to users.

WIPO International Publication Number WO 02/29664, invented by Park on Apr. 11, 2002, illustrates an electronic medical record including an electronic prescription system that will transmit the electronic medical record, including prescription information etc., of patient treatment issued by a doctor, to another doctor or pharmacist. Again, while this system does provide medical professionals with an easier way of obtaining information, it still provides users with no real convenience because the users would still have to conduct a face-to-face encounter with both the doctor and the pharmacist.

Furthermore, relevant art has attempted to deal with convenient access to pharmaceuticals and medical care through technology. U.S. Pat. No. 6,438,451, issued to Dinicola, on Aug. 20, 2002, discloses a network of interactive, self-service, medication dispensing kiosks that are adaptable to contain different drugs. While these kiosks are unmanned, eliminating the user's interaction with a pharmacist, the user would still need to obtain a prescription from a doctor, which does not eliminate the inconvenience or embarrassment on the user. Also, a user would have to drive to one of these kiosks, which may in fact be relatively far, further inconveniencing the user. U.S. Patent Publication No. 2002/0062175, published by Lion, on May 23, 2002 discloses another kiosk system that will incur the same problems as the Dinicola invention.

WIPO International Publication No. WO 02/09580, invented by Hade, on Feb. 7, 2002, discloses an invention that allows an online medical evaluation where a patient will answer questions and a physician will develop a diagnosis and compose a list of possible treatments. While the Hade publication provides the user with an ability to have limited interaction with a physician, the user will still have to deal with the pharmacy aspect of the equation. Further, the user cannot be drug specific when choosing what type of medication the user would like to take.

U.S. Patent Publication No. 2003/0018495, invented by Sussman, on Jan. 23, 2003, discloses a system by which an individual can make an appointment with a doctor, talk to the doctor online, request to fill a prescription, and receive an electronic receipt and notification of the readiness of the prescription. While this system allows the user to talk to the doctor online, a visit will oftentimes be necessary because the doctor will not make a diagnosis online. Furthermore, while the request for a prescription can be made online, the Sussman invention requires that the user pick up the prescription, therefore must confront a pharmacist, not eliminating the inconvenience, risk and possible embarrassment associated with face-to-face contact.

Relevant art has finally attempted to solve patient inconvenience by developing self-treatment options. U.S. Pat. No. 6,540,672, issued to Simonsen, et al., on Apr. 1, 2003, discloses a system with a module that generates and stores information, which is transmitted to a computer or database, in which the user will be able to obtain guidance relating to how they should administer medicine. While this does provide a user with the convenience of not necessarily having to go to the doctor every time they administer medicine, users are still required to complete an initial visit to a physician in order to get an initial prescription of their medication. The user, further, has to go to the pharmacy in order to obtain the medication.

U.S. Pat. Publication No. 2002/0007288, invented by Endou on Jan. 17, 2002, discloses a home medical examination treatment system that allows a user to request and fill out a medical form, allows doctors to take medical forms and compile into an examination chart, allows physicians to diagnose and send prescriptions to pharmacies, and allows pharmacies to receive prescriptions and send it to a user. While this does provide an easier method for the user, the user does not have the opportunity to choose the medication, nor does he have any control over whether he will actual receive medication or simply just a diagnosis. Unlike the present invention, the Endou patent publication requires a user to have contact with a physician first, not being able to acquire the type of medication that the user desires.

Finally, U.S. Pat. Publication No. 2003/0120513, invented by Samaquial, on Jun. 26, 2003, discloses a method of using a real-time interactive interface that allows a user to search for remote practitioners, a user and physicians to conduct an online consultation, a physician to identify a suitable pharmacy, and a physician to order a necessary. Furthermore, the user cannot order drug-specific prescriptions, therefore does not have any control over what medications they can or cannot take.

Considering the above patents and patent publications, there exists a need for an Internet service for professional services using independently licensed physicians and pharmacist offering only FDA approved medications for conditions which can be managed without direct physical contact, yet maintaining the highest professional ethics and Internet security standards. SUMMARY OF THE INVENTION

The present invention solves the problem of the inability of patients to get medical advice and medical prescriptions over the Internet. The present invention involves four levels of services (1) a website on the Internet, (2) a contact with licensed physicians to review the data collected by the present invention, (3) a licensed pharmacist to fill the prescription and (4) an integrated management system to control the operation of (1), (2), and (3). The invention covers the acquisition of medical data or information electronically, analysis of the data by a physician, and the prescribing of a medication.

### BRIEF DESCRIPTION OF THE DRAWINGS

FIG. 1 depicts the relationship between the Internet website, licensed physicians, the licensed pharmacists and the integrated management control pathways of the present.

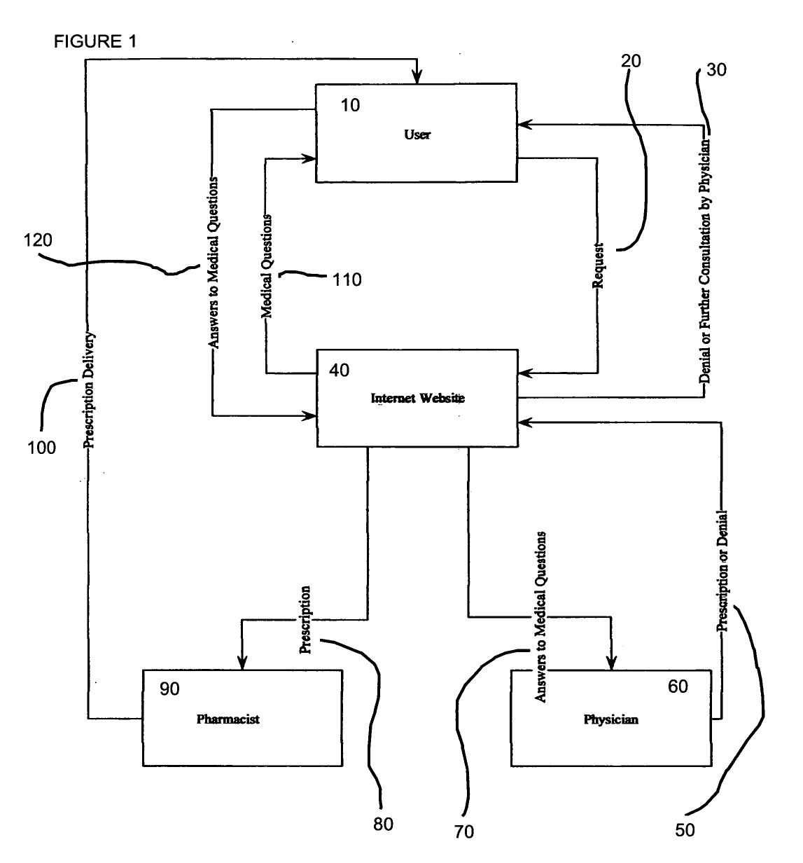

### DETAILED DESCRIPTION OF THE PREFERRED EMBODIMENT(s)

The present invention includes an internet website (40), a group of licensed physicians (60), and a group of licensed pharmacists (90). The present invention has an integrated management control system that orchestrates the internal workings among the website (40), licensed physician (60) and the pharmacist (90). The internet website (40) allows users (10) to search for information regarding the medical services and products offered by the website (40). The website (40) is comprised of various graphics, links, pictures and other information that explains the services offered by the present invention. The website (40) is a virtual shopping and information domain for users (10) to shop for prescription medications and medical services. The present invention allows the user (10) to browse for prescription medicine as well as order prescription medications through the present invention. Once the user (10) requests (20) a medication, the website (40) acts as a conduit, transmitting the information gathered from the user (10) to the physician (60). At this point, the user (10) will answer a series of medical questions (110), send the answers back to the website (120) and will become a patient. The present invention further contacts the pharmacy (90) if the physician (60) decides to grant the prescription. For the user (10), there is a slight delay in between the time of their request (20) and prescription delivery (100) via mail or other delivery service. During the delay, the physician (60) is reviewing the answers to the medical questions (70) and making the decision as to whether or not to grant the prescription (50). If the prescription is granted, the physician (60) contacts (50) the website (40), and the prescription is then sent to the pharmacy (90). During this process the user (10) does not have any contact with the physician (60), unless the physician (60) needs further information from the user (10). The present invention is further described below.

The user (10) learns that the website (40) offers users (10) complete privacy, discretion and dignity while addressing medical issues including but not limited to sexual dysfunction, obesity, Bioterrorism/Public Health Emergencies, pregnancy prevention, excess/unwanted facial hair, infection and baldness. The users (10) learns that the website (40), will help the user (10) make medical decisions, and provide professional consultation to determine whether the requested medicine should be prescribed for the user (10).

Because the website (40) offers worldwide medical consultations and prescriptions, the user (10) can read the information in several languages, currently including German, French, Italian, Spanish, English, and Japanese. Users (10) can access all links on the website (40) and the text will appear in one of the six languages noted above.

At the website (40), and under the tab, ‘ Order Form”, there is an informational section that explains that the symptoms associated with the medical conditions or diseases that may prompt the user (10) to request a particular medication offered at the website (40). Information on these topics is available at the website (40) and assure user (10) of their privacy and that all matters concerning medical conditions and prescriptions sought are held in strict confidentiality.

Once the user (10) decides to use the services of the present invention, they can access the medical questionnaire (110) on the website (40). Before the medical questionnaire begins, the user (10) must agree to a disclaimer informing the patient of the goal of the present invention, which is to prescribe medicine that, is safe for the patient to take. The user is advised that the services and medical questionnaire (110) are not designed to diagnosis serious life threatening disease. The disclaimer warns that symptoms can be caused by other serious medical conditions, and that the medical questionnaire (100) is not a substitute for physician diagnosis of any potential serious, life threatening diseases.

The medical questions contained in the medical questionnaire (110) direct the user (10) to answer questions regarding 1) the consent to medical care, 2) the establishment of a patient-physician relationship, 3) an explanation that the user can request a consultation with a licensed physician, 4) an explanation that the user must answer all questions accurately, honestly and fully or risk harm or loss of life or limb and 5) any specific and general medical and health related questions included but not limited to if the user (10) has had previous specific diagnoses of atherosclerosis, low testosterone, diabetes, prostrate cancer, hypertension, cirrhosis of the liver, anxiety, heart attack, endocrine disorders, stroke, kidney disease, spinal cord injury, thyroid disease, and/or enlarged prostate:

It further asks whether the user is on dialysis, has had an organ transplant, or has a pacemaker. The user (10) is asked to list all medications, and is specifically asked whether the user (10) is taking nitroglycerine, erythromycin, ketoconazole, cimetidine, itraconazole, mibefradil, FloMax, Hytrin, Minipres, Uroxatral, Xatral or Cardura. The present invention further asks the user (10) to list all known allergies, past surgical history, disease and disorders in the family, and whether they drink or smoke. An example of a possible question involving the prescription of Viagra, a user (10) in the present invention can be asked how their impotency (erectile dysfinction) evolved, whether related to the finctioning of their penis, and or due to medical problems associated with blood pressure, cholesterol, depression, chest pains, shortness of breath, and or dizziness. The present invention asks the user (10) whether they have been diagnosed with Multiple Myeloma, Sickle Cell Anemia, Curvature of the penis (Peyronie's disease), Leukemia, Bleeding Disorders, Active peptic ulcer, and Retinitis pigmentosa.

The present invention further asks the user (10) to respond truthfully to all statements and medical questions contained in the medical questionnaire (110) and to agree to the language of the Waiver of Liability. The questionnaire (110) requires the user (10) to read and agree to the conditions for using the present invention. The present invention requires that the user (10) provide a telephone number so the licensed physicians (60) or pharmacist (90) can reach the user in the event that the physician believes that it is necessary for a consultation. The present invention assures the user (10) that no messages will be left and directs the user (10) to provide a convenient time for the returned call. The present invention verifies other information for the user's (10), including the user's (10) mailing address, billing information, and other information for the physicians' (60) and pharmacies' (90) use.

Once the user (10) completes the questionnaire (110), the answers (120) are returned to the website (40), and the website (40) sends the answers (70) to the physician (60). The licensed physician (60) reviews the answers (70) and decides whether to prescribe the user (10) the prescription. The physician (60) will either 1) deny the prescription based on the medical information provided by the user (50), or 2) grant the prescription for the user (10), in which the internet website (40) contacts (80) the pharmacy (60) to dispense the prescription or 3) requests a consultation (30) with the user (10) to gather further information necessary to determine whether the user (10) is a candidate for the medication sought.

Once the physician (30) approves the prescription, the physician (30) transmits (50) to the pharmacy (60) their approval to the pharmacy (50) and the pharmacy (60) dispenses (70) the medication to the user (client).

The website (40) provides a tab for the user (10) to place refill orders and a price list of all prescription medications available on the website (40). The website (40) features a tab and link for health news. This is a tab where the latest medical updates, medication information, user (10) testimonies, news releases, health journal articles and other recent information is posted. The website (10) also posts the privacy policy for the present invention and there is a tab for users (10) to email the physicians (60). The internal functions of the present invention are controlled by the integrated management control system.

1. An improved method of requesting medication online comprising the steps of:
requesting medication online by a user;
sending a medical questionnaire to said user;
receiving answers to said medical questionnaire from said user;
sending answers to said medical questionnaire to a physician, wherein there is no direct interaction between said user and said physician;
receiving a prescription or denial of prescription from said physician; and
sending said prescription to a pharmacist for delivery.

2. The improved method of requesting medication online of claim 1, further comprising the step of determining whether said users qualify medically for the prescription medication sought.

3. The improved method of requesting medication online of claim 1, further comprising the step of determining whether a user qualifies medically to safely use the prescription medication sought.

4. The improved method of requesting medication online of claim 1, further comprising the step of asking said user to answer said medical questionnaire accurately and truthfully.

5. The improved method of requesting medication online of claim 1, wherein said physician may only contact said user if further consultation is necessary.

6. The improved method of requesting medication online of claim 1, wherein said pharmacist dispenses medication to said user.
